(19) United States
(12) Patent Application Publication
(10) Pub. No.: US 2010/0030481 A1
(43) Pub. Date: Feb. 4, 2010

(54) Dating hemorrhage

(76) Inventor: Roscoe Atkinson, San Juan Capistrano, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/454,928

(22) Filed: May 26, 2009

Related U.S. Application Data
(63) Continuation of application No. 11/396,052, filed on Mar. 31, 2006, now abandoned.
(60) Provisional application No. 60/668,414, filed on Apr. 4, 2005.

(51) Int. Cl. G06F 19/00

(52) U.S. Cl. 702/19

(57) ABSTRACT

Systems and techniques for dating hemorrhage. In one aspect, a method includes receiving one or more hemorrhage samples that provide information relevant to dating of a hemorrhage, receiving timing information describing timing of the hemorrhage, staining the hemorrhage samples with two or more stains, quantifying two or more parameters that quantitatively characterize two or more properties of the hemorrhage samples on the basis of the staining by the two or more stains, and forming a hemorrhage database that includes the timing information in association with the staining parameters.

### CROSS-REFERENCE TO RELATED APPLICATION

This application is a continuation of application Ser. No. 11/396,052 filed Mar. 21, 2006, which claims the benefit of U.S. Provisional Application Ser. No. 60/668,414, filed on Apr. 4, 2005, and entitled “Accurate Determination of Hemorrhage Age using Instrumentation and Image Analysis,” said applications being hereby fully incorporated herein by reference.

### BACKGROUND

This disclosure relates to dating hemorrhage.

Hemorrhage is the discharge of blood from a blood vessel and is colloquially referred to as “bleeding.” Hemorrhage can be internal in that blood is discharged inside the body or external in that blood is discharged outside the body. Hemorrhage can be associated with a variety of disease states, disorders, and injuries. For example, hemorrhage can result from injury or blood vessel abnormalities.

Hemorrhage can be dated, e.g., the timing of blood discharge can be determined. Hemorrhage dating can be used in clinical, therapeutic, diagnostic, and forensic contexts. For example, the time when blood discharge commenced can be used to determine the time of injury to a deceased individual.

### SUMMARY

Systems and techniques for dating hemorrhage are described.

In one aspect, a method includes receiving one or more hemorrhage samples that provide information relevant to dating of a hemorrhage, receiving timing information describing timing of the hemorrhage, staining the hemorrhage samples with two or more stains, quantifying two or more parameters that quantitatively characterize two or more 1 properties of the hemorrhage samples on the basis of the staining by the two or more stains, and forming a hemorrhage database that includes the timing information in association with the staining parameters.

This and other aspects can include one or more of the following features. The staining of an untimed hemorrhage sample can be correlated with information in the hemorrhage database to determine at least some timing information for the untimed hemorrhage sample. Two or more physiological parameters of the hemorrhage samples can be quantified. For example, one or more of macrophage density, fibrosis, and endothelial cell density can be quantified. As another example, one or more of factor VIII concentration, neutrophil density, lymphocyte density, and hemosiderin density can be quantified.

Two or more staining parameters of the hemorrhage samples can be quantified. The method can also include receiving a macroscopic parameter that characterize the hemorrhage without examination using a microscope, and associating the macroscopic parameter with other information in the hemorrhage database. For example, one or more of an age of an individual from which the hemorrhage samples are drawn, a gender of the individual, a size of the hemorrhage, a location of the hemorrhage, and an ethnic background of the individual can be received. As another example, an identification of another health condition of the individual from which the hemorrhage samples are drawn can be received, such as one or more of anemia, infection, diabetes, and sepsis. As another example, an identification of another physiological characteristic of an individual from which the hemorrhage samples are drawn, such as one or more of a peripheral blood value, a white blood cell count, a platelet count, a presence of disseminated intravascular coagulation, a pregnancy, a body weight, a percent body fat, and a historical blood pressure. As another example, an identification of the hemorrhage as an arterial hemorrhage or a venous hemorrhage can be received. As another example, a category of an injury from which the hemorrhage samples are drawn can be received. As another example, one or more of a parameter related to an environment surrounding an individual from which the hemorrhage samples are drawn, a parameter related to a medication of the individual, and a parameter related to an activity level of the individual can be received.

The hemorrhage samples can be stained with one or more of hematoxylin and eosin (H&E) stain, trichrome stain, and iron stain. The hemorrhage samples can also be stained with one or more of CD-31, MRP-8, MRP-14, CD-68, and CD-45.

In another aspect, a memory is for storing data for access by operations performed by a data processing system. The memory includes a data assembly stored in the memory. The data assembly associates timing information describing the time course of one or more hemorrhages and microscopic parameter information that quantitatively characterizes two or more traits of the one or more hemorrhages that are not visible to the naked eye.

This and other aspects can include one or more of the following features. The microscopic parameter information can reflect quantitative microscopic examination of staining with two or more stains of one or more hemorrhage samples drawn from the hemorrhages.

The microscopic parameter information can quantitatively characterize two or more physiological parameters of one or more hemorrhage samples drawn from the hemorrhages. For example, the microscopic parameter information can quantitatively characterize one or more of macrophage density, fibrosis, and endothelial cell density. As another example, the microscopic parameter information can quantitatively characterize one or more of factor VIII concentration, neutrophil density, lymphocyte density, and hemosiderin density. As another example, the microscopic parameter information can quantitatively characterize one or more of red blood cell color, red blood cell density, and the spatial distribution physiological parameters.

The microscopic parameter information can quantitatively characterize two or more staining parameters of one or more hemorrhage samples drawn from the hemorrhages. For example, the microscopic parameter information can quantitatively characterize two or more of an intensity of staining and area percent that is stained, a spatial pattern of staining, and an optical property of a stain.

The microscopic parameter information can reflect quantitative microscopic examination of staining with one or more of hematoxylin and eosin (H&E) stain, trichrome stain, and iron stain. The microscopic parameter information can reflect quantitative microscopic examination of staining with one or more of CD-31, MRP-8, MRP-14, CD-68, and CD-45.

The data assembly can associate the timing information with the microscopic parameter information in a data table. The data assembly can associate the timing information with the microscopic parameter information in a mathematical expression of the relationship between the timing information and the microscopic parameter information.

The details of one or more implementations are set forth in the accompanying drawings and the description below. Other features and advantages will be apparent from the description and drawings, and from the claims.

### DESCRIPTION OF DRAWINGS

FIG. 1 is a schematic illustration of a system that can be used to date hemorrhage;

FIG. 2 is a schematic illustration of a hemorrhage sample;

FIG. 3 is a schematic illustration of one implementation of data processing system;

FIG. 4 is a flowchart of a process for dating hemorrhage;

FIG. 5 is a schematic representation of a subset of the contents of a hemorrhage database;

FIG. 6 is a flowchart of a process for dating hemorrhage;

FIG. 7 is a schematic representation of a subset of the contents of a hemorrhage database;

FIG. 8 is a flowchart of a process for dating hemorrhage;

FIG. 9 is a schematic representation of a subset of the contents of a hemorrhage database; and

FIG. 10 is a flowchart of a process for dating hemorrhage;

Like reference symbols in the various drawings indicate like elements.

### DETAILED DESCRIPTION

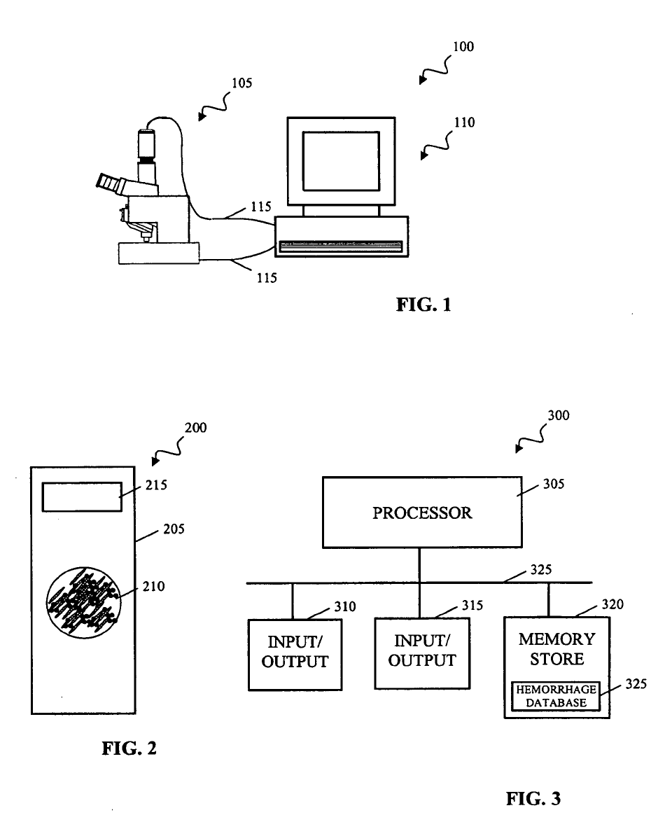

FIG. 1 is a schematic illustration of a system 100 that can be used to date hemorrhage. System 100 includes a microscope system 105, a data processing system 110, and one or more data links 115.

Microscope system 105 is a system for imaging objects or features that are not visible to the naked eye. The objects or features can be too small to be resolved or they can have other characteristics that are not transduced by the naked eye. For example, the objects or features can emit or reflect light in the infrared region of the electromagnetic spectrum. Microscope system 105 can image objects or features by generating image data that is suitable for reconstructing a two-dimensional view or by generating other measures that provide information about the imaged objects or features, such as the net intensity as a function of wavelength.

Microscope system 105 can thus include an optical microscope, along with various interfaces for exchanging data and instructions with one or more data processing system 110 over data links 115. Microscope system 105 can be a digital microscope with built-in data processing capabilities, such as the Automated Cellular Imaging System (“ACIS”, Clarient Inc., San Juan Capistrano, Calif.), which provides automated microscopy and image analysis capabilities.

Data processing system 110 is one or more analog or a digital signal or data processing device and/or software that performs processing activities in accordance with set of processing logic. The processing logic can be set forth in an arrangement of hardware, a set of machine readable instructions, and/or combinations thereof. Instructions and/or data for the processing activities can be stored in hardware and/or software. Data processing system 110 can thus include a personal computer. Data processing system 110 can be dedicated to operation with microscope system 105 or data processing system 110 can be a remote system that communications with microscope system 105 over a data communications network of data links 115.

FIG. 2 is a schematic illustration of a hemorrhage sample 200. Sample 200 includes a microscopy slide 205 on which tissue 210 has been prepared for imaging by microscope system 105. Tissue 210 is generally tissue from the vicinity of a hemorrhage and can be prepared by fixing, sectioning, staining, and/or other procedures to provide information relevant to the dating of a hemorrhage.

Microscopy slide 205 can also include a barcode or other label 215 that can aid in the automated identification of microscopy slide 205. For example, label 215 may be readable using one or more barcode or other readers in system 100 (not shown).

FIG. 3 is a schematic illustration of one implementation of data processing system 300. Data processing system 300 can be part of one or both of microscopy system 105 and data processing system 110 (FIG. 1). Data processing system 300 includes a processor 305 that is in data communication with one or more input/output devices 310, 315 and a memory store 320 over a data bus 325. Processor 305 is a data processing device such as a central processing unit that performs operations in accordance with the logic of a set of machine-readable instructions. For example, processor 305 can be responsible for performing operations for dating hemorrhage, such as those discussed further below.

Input/output device 310 can interface with a microscope to exchange instructions and other data. For example, input/output device 310 can include one or more of a serial or parallel port, a modem, a network card, or a dedicated microscopy card. Input/output device 315 can interface with a human to exchange instructions and other data. For example, input/output device 315 can include one or more of a keyboard, a mouse, a touch screen, a touchpad, a monitor, a printer, or other device.

Memory store 320 is a device that retains a physical state indicative of information for an interval of time. The retained state can reflect machine-readable instructions and other data. Memory store 320 can be any of a number of different memory types and can be implemented as a chip, a card, a disc, or other memory device.

Among the information retained at memory store 320 is a hemorrhage database 325. Hemorrhage database 325 is a structured collection of information related to the dating of hemorrhage. The information stored at hemorrhage database 325 can be accessed by processor 305 while performing operations for dating hemorrhage.

As discussed further below, hemorrhage database 325 can include information descriptive of a time relationship between a hemorrhage and one or more parameters. The information can relate to staining parameters, physiological parameters, other, nonmicroscopic, parameters, and the like. The information can relate to the values of those parameters as a function of time. For example, the information can relate to expected values of those parameters as a function of time after a hemorrhage has started. As another example, the information can relate to how the values of some parameters are changed by the values of other parameters.

The information in hemorrhage database 325 can reflect the results of measurements made upon multiple hemorrhages in a variety of different contexts. For example, the information in hemorrhage database 325 can reflect the results of repeated measurements upon a variety of different hemorrhages with known time sequences, as discussed further below.

Hemorrhage database 325 can be implemented as any of a number of different data structures. For example, hemorrhage database 325 can be implemented as a one or more data tables. As another example, hemorrhage database 325 can be implemented as a record of one or more mathematical relationships, or coefficients in a mathematical relationship, that describe a time relationship between one or more parameters and the timing of a hemorrhage.

FIG. 4 is a flowchart of a process 400 for dating hemorrhage. Process 400 can be performed in whole or in part by one or more systems for dating hemorrhage such as system 100 (FIG. 1).

The system performing process 400 can receive one or more hemorrhage samples that have been stained with multiple stains at 405. The hemorrhage samples can include serial sections of tissue and/or an individual section that has been stained with multiple discernable stains. The stains can include a dye, a stain, an antibody, a fluorescent probe, a fluorescent label, and the like. For example, the stains can include histochemical stains and/or immunohistochemical stains.

Example histochemical stains include hematoxylin and eosin (H&E) stain, trichrome stain, and iron stain (i.e., Prussian blue). The hematoxylin and eosin stain provides information indicative of red blood cell density and color in a hemorrhage sample. The trichrome stain provides information indicative of collagen deposition by fibroblasts (i.e., fibrosis) in a hemorrhage sample. The iron stain provides information indicative of the presence of hemosiderin in a hemorrhage sample. Hemosiderin is a breakdown product of hemoglobin.

Example immunohistochemical stains include CD-31, MRP-8, MRP-14, CD-68, and CD-45. CD-31 provides information indicative of the presence of endothelial cells in a hemorrhage sample. Endothelial cells line the inner tube of blood vessels, including new blood vessels that form during any repair of a hemorrhage site. MRP-8, MRP-14, and CD-68 all provide information indicative of the presence of macro phages and/or their precursors in a hemorrhage sample. Macrophages are cells that enter a hemorrhage site and digest red blood cells. CD-45 provides information indicative of the presence of lymphocytes in a hemorrhage sample. Lymphocytes mediate humoral and cellular immunity and lymphocyte counts generally increase in response to hemorrhaging.

The system performing process 400 can quantify staining parameters at 410. The quantification of staining or other parameters involves making experimental measurements and expressing the results of those measurements as a quantity. Staining parameters thus quantitatively characterize properties of hemorrhage sample(s) that are impacted by staining. The characterized properties can be optical properties. For example, the quantitatively characterized properties can include, e.g., the intensity of staining, the area percent of a hemorrhage sample that is stained, the spatial pattern of staining, the optical properties of stains themselves (e.g., absorption spectra, emission spectra), and the like.

Staining parameters can be quantified manually or in an automated fashion (i.e., without human intervention). For example, staining parameters can be quantified using image analysis software such as provided by the Automated Cellular Imaging System (“ACIS”, Clarient Inc., San Juan Capistrano, Calif.).

The system performing process 400 can correlate the quantified staining parameters with contents of a hemorrhage database at 415. The correlation can be performed in a number of ways. For example, the correlation can include comparing the quantified staining parameters to values in a data table that are associated with certain times in hemorrhage. As another example, the correlation can include calculating the time of hemorrhage based on the quantified staining parameters and a mathematical relationship set forth in the hemorrhage database.

The system performing process 400 can output hemorrhage dating information at 420. The output hemorrhage dating information can include, e.g., the approximate time when hemorrhage started, the approximate time between the start hemorrhage and death, charts or graphs that can be used to determine these times, and the like. The output hemorrhage dating information can also include diagnostic information. For example, when the timing of hemorrhage is known, the output hemorrhage dating information can include predictions of disease states.

The hemorrhage dating information can be output to a human or to a second data processing device. For example, the hemorrhage dating information can be output using a visual display device, a printer, a speaker, a data stream on an output port, an electromagnetic wave, or the like.

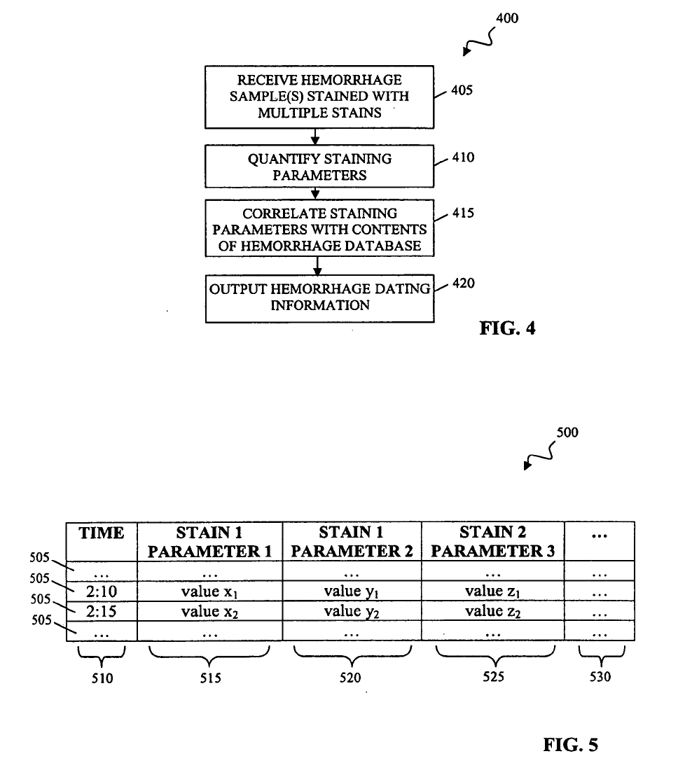

FIG. 5 is a schematic representation of a subset of the contents of a hemorrhage database 500. Hemorrhage database 500 can be used in isolation or in conjunction with other hemorrhage database information. For example, hemorrhage database 500 can be used in conjunction with equations or other mathematical relationships.

Hemorrhage database 500 is a data table that organizes information into a set of rows 505 and columns 510, 515, 520, 525, 530 to indicate associations within that information. For example, hemorrhage database 500 includes a time column 510, staining parameter columns 515, 520,525 and additional information 530. Time column 510 includes timing information, such as the time since the onset of hemorrhage. Staining parameter columns 515, 520, 525 include information relating to various staining parameters. For example, staining parameter column 515 can include information describing the values of a first parameter associated with a first stain at the times set forth in time column 510. Staining parameter column 520 can include information describing the values of a second parameter associated with the first stain at the times set forth in time column 510. Staining parameter column 525 can include information describing the values of a third parameter associated with a second stain at the times set forth in time column 510. Additional information 530 can include one or more additional columns, including one or more additional parameter columns, to indicate associations with the information in columns 510, 515, 520, 525.

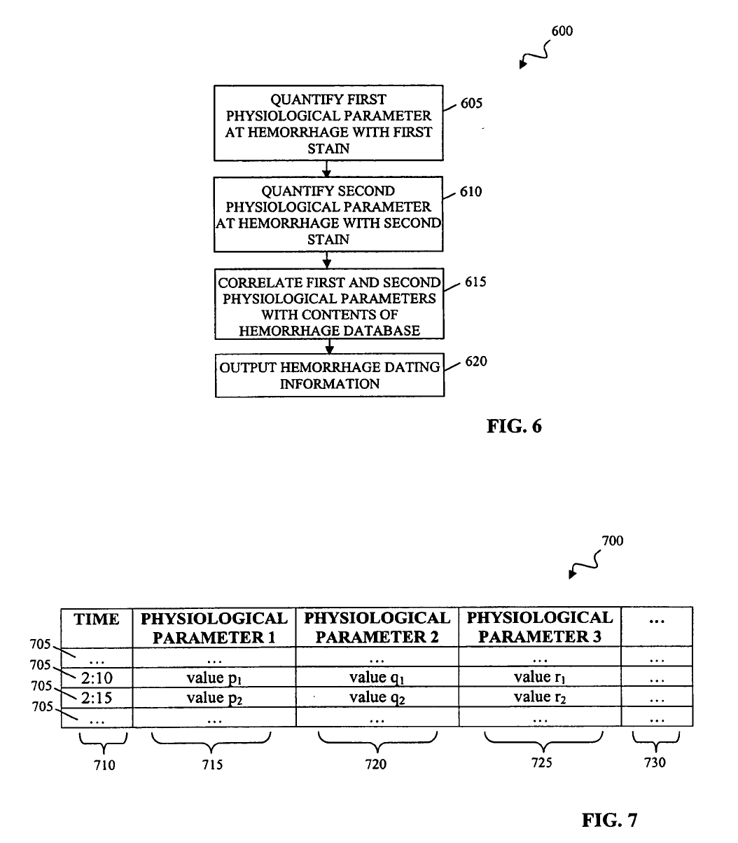

FIG. 6 is a flowchart of a process 600 for dating hemorrhage. Process 600 can be performed in whole or in part by one or more systems for dating hemorrhage, such as system 100 (FIG. 1). Process 600 can be performed as an isolated set of activities or in conjunction with other activities for dating hemorrhage. For example, process 600 can be performed in conjunction with process 400 (FIG. 4).

The system performing process 600 can quantify a first physiological parameter at a hemorrhage using a first stain at 605 and a second physiological parameter at the hemorrhage using a second stain at 610. Physiological parameters quantitatively characterize one or more aspects of the physiology of one or more hemorrhage sample(s). Physiological parameters can be quantified based on the optical properties of one or more hemorrhage samples after staining. For example, the first physiological parameter can be quantified from a first section of tissue stained using a first stain and the second physiological parameter can be quantified from a second section of tissue stained using a second stain. As another example, both the first physiological parameter and the second physiological parameter can be quantified from the same section of tissue after staining with both a first stain and a second stain, where the first and second stains are distinguishable, optically or otherwise.

Physiological parameters can be quantified manually or in an automated fashion (i.e., without human intervention). For example, physiological parameters can be quantified using image analysis software such as provided by the Automated Cellular Imaging System (“ACIS”, Clarient Inc., San Juan Capistrano, Calif.).

Example physiological parameters include macrophage density, fibrosis, endothelial cell density, factor VIII concentration, neutrophil density, lymphocyte density, hemosiderin density, red blood cell color, red blood cell density, and the spatial distribution of these and other physiological parameters. The physiological elements quantified by these parameters (i.e., the cells, proteins, proteins, glycoproteins, etc.) can be identified using, e.g., the stains discussed above.

The system performing process 600 can correlate the first and second physiological parameters with contents of a hemorrhage database at 615. The correlation can be performed in a number of ways. For example, the correlation can include comparing the physiological parameters to values in a data table that are associated with certain times in hemorrhage. As another example, the correlation can include calculating the time of hemorrhage based on the physiological parameters and a mathematical relationship set forth in the hemorrhage database.

The system performing process 600 can output hemorrhage dating information at 620. The output hemorrhage dating information can include, e.g., the approximate time when hemorrhage started, the approximate time between the start hemorrhage and death, charts or graphs that can be used to determine these times, and the like. The output hemorrhage dating information can also include diagnostic information. For example, when the timing of hemorrhage is known, the output hemorrhage dating information can include predictions of disease states.

FIG. 7 is a schematic representation of a subset of the contents of a second hemorrhage database 700. Hemorrhage database 700 can be used in isolation or in conjunction with other hemorrhage database information. For example, hemorrhage database 700 can be used in conjunction with hemorrhage database 500 (FIG. 5).

Hemorrhage database 700 is a data table that organizes information into a set of rows 705 and columns 710, 715, 720, 725, 730 to indicate associations within that information. For example, hemorrhage database 700 includes a time column 710, physiological parameter columns 715, 720,725 and additional information 730. Time column 710 includes timing information, such as the time since the onset of hemorrhage. Physiological parameter columns 715, 720, 725 include information relating to various physiological parameters. For example, physiological parameter column 715 can include information describing macrophage density at the times set forth in time column 710. Staining parameter column 720 can include information describing the onset of fibrosis at the times set forth in time column 710. Staining parameter column 725 can include information describing endothelial cell density at the times set forth in time column 710. Additional information 730 can include one or more additional columns, including one or more additional physiological parameter columns, to indicate associations with the information in columns 710, 715, 720, 725.

FIG. 8 is a flowchart of a process 800 for dating hemorrhage. Process 800 can be performed in whole or in part by one or more systems for dating hemorrhage, such as system 100 (FIG. 1). Process 800 can be performed as an isolated set of activities or in conjunction with other activities for dating hemorrhage. For example, process 800 can be performed in conjunction with process 400 (FIG. 4) and/or process 600 (FIG. 6).

The system performing process 800 can receive one or more microscopic parameters at 805. Microscopic parameters quantitatively characterize one or more traits of one or more hemorrhage sample(s) that are not visible to the naked eye. For example, staining parameters and physiological parameters quantified based on the extent of staining can be microscopic parameters. Microscopic parameters can be quantified from one or more hemorrhage samples, using one or more stains, using one or more hemorrhage databases as needed.

The system performing process 800 can receive one or more macroscopic parameters at 810. Macroscopic parameters characterize one or more traits of one or more hemorrhage sample(s) that can be characterized without examination of a hemorrhage sample using a microscope. Please note that macroscopic parameters need not be visible to the naked eye. For example, the fact that a hemorrhage sample is drawn from an anemic or diabetic individual is a macroscopic parameter even though the individual's condition is not necessarily visible to the naked eye. Examples of macroscopic parameters include the age of the individual from which a hemorrhage sample is drawn, the gender of the individual from which a hemorrhage sample is drawn, the size of the hemorrhage from which a hemorrhage sample is drawn, the location of the hemorrhage from which a hemorrhage sample is drawn, the ethnic background (e.g., race) of the individual from which a hemorrhage sample is drawn, other health conditions of the individual from which a hemorrhage sample is drawn (including, e.g., anemia, infection, diabetes, sepsis, and the like), other physiological characteristics of the of the individual from which a hemorrhage sample is drawn (including, e.g., peripheral blood values, white blood cell count, platelet count, the presence of disseminated intravascular coagulation, pregnancy, body weight, percent body fat, historical blood pressure, and the like), the type of hemorrhage from which a hemorrhage sample is drawn (e.g., arterial hemorrhage or venous hemorrhage), the type of injury from which a hemorrhage sample is drawn, the environment surrounding the individual from which a hemorrhage sample is drawn (e.g., temperature, humidity, season), any medication of the individual from which a hemorrhage sample is drawn, and the activity level of the individual from which a hemorrhage sample is drawn.

The system performing process 800 can correlate the microscopic and macroscopic parameters with contents of a hemorrhage database at 815. The correlation can be performed in a number of ways. For example, the correlation can include comparing the microscopic and macroscopic parameters to values in a data table that are associated with certain times in hemorrhage. As another example, the correlation can include calculating the time of hemorrhage based on the microscopic and macroscopic parameters and a mathematical relationship set forth in the hemorrhage database. The system performing process 800 can output hemorrhage dating information at 820. The output hemorrhage dating information can include, e.g., the approximate time when hemorrhage started, the approximate time between the start hemorrhage and death, charts or graphs that can be used to determine these times, and the like. The output hemorrhage dating information can also include diagnostic information. For example, when the timing of hemorrhage is known, the output hemorrhage dating information can include predictions of disease states.

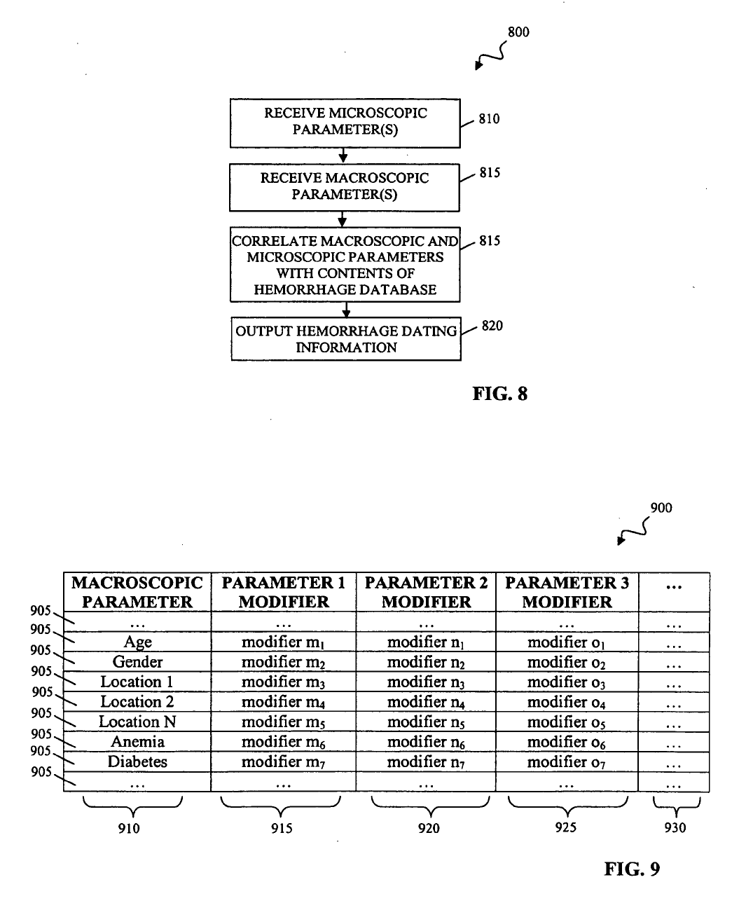

FIG. 9 is a schematic representation of a subset of the contents of a third hemorrhage database 900. Hemorrhage database 900 can be used in isolation or in conjunction with other hemorrhage database information. For example, hemorrhage database 900 can be used in conjunction with hemorrhage database 500 (FIG. 5) and/or hemorrhage database 700 (FIG. 7).

Hemorrhage database 900 is a data table that organizes information into a set of rows 905 and columns 910,915,920,925,930 to indicate associations within that information. For example, hemorrhage database 900 includes a macroscopic parameter column 910, parameter modifier columns 915, 920, 925, and additional information 930. Macroscopic parameter column 910 includes information identifying one or more macroscopic parameters. Parameter modifier columns 915, 920, 925 include information relating to the modification of various parameters in light of the macroscopic parameters identified in macroscopic parameter column 910. For example, parameter modifier column 915 can include information describing the impact of the macroscopic parameters identified in macroscopic parameter column 910 on macrophage density. Parameter modifier column 920 can include information describing the impact of the macroscopic parameters identified in macroscopic parameter column 910 on the uptake of trichrome stain. Parameter modifier column 925 can include information describing the impact of the macroscopic parameters identified in macroscopic parameter column 910 on endothelial cell density. Additional information 925 can include one or more additional columns, including one or more additional parameter modifier columns, to indicate associations with the information in columns 910, 915, 920, 925.

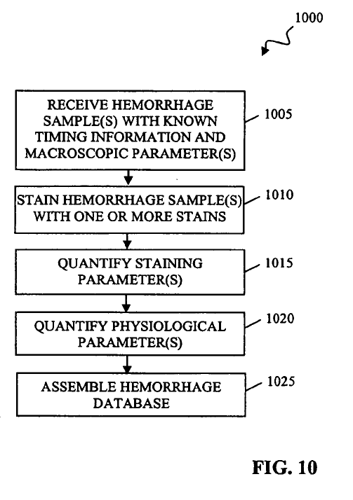

FIG. 10 is a flowchart of a process 1000 for dating hemorrhage. Process 1000 can be performed in whole or in part by one or more systems for dating hemorrhage, such as system 100 (FIG. 1). Process 1000 can be performed as an isolated set of activities or in conjunction with other activities for dating hemorrhage. For example, process 1000 can be performed in conjunction with process 400 (FIG. 4), process 600 (FIG. 6), and/or process 800 (FIG. 8).

The system performing process 1000 can receive one or more hemorrhage samples with known timing information at 1005. The known timing information can include, e.g., the time when hemorrhage started, the time of death, and/or the timing of any treatment of the hemorrhage. The hemorrhage sample can also be characterized by one or more macroscopic parameters, such as various characteristics of the individual from which the hemorrhage samples are drawn.

The system performing process 1000 can stain the one or more hemorrhage samples using one or more stains at 1010. The staining can be done automatically or in conjunction with a human. The staining can result in multiple samples each being stained with multiple stains or in a single sample being stained with multiple stains that are optically or otherwise distinguishable.

The system performing process 1000 can quantify one or more staining parameters at 1015. The quantification can be an optical measurement using an optical microscope that provides automated microscopy and image analysis capabilities, such as the Automated Cellular Imaging System.

The system performing process 1000 can also quantify one or more physiological parameters at 1020. The physiological parameters can be quantified at least in part on the quantified staining parameters. The physiological parameters can also be quantified based, in part, on one or more macroscopic parameters that characterize the hemorrhage sample.

The system performing process 1000 can assemble a hemorrhage database at 1020. The system can use or omit timing information, macroscopic parameters, staining parameters, and/or physiological parameters as appropriate. The hemorrhage database can reflect the content of quantification efforts on several hemorrhage sample(s), including those stained and/or quantified by others. Multiple quantification efforts can be averaged or otherwise combined to decrease the uncertainty associated with each individual quantification effort.

The hemorrhage database can set forth associations between timing information, macroscopic parameters, staining parameters, and/or physiological parameters in a variety of different data structures, including tabular and/or mathematical form. A hemorrhage database need not include all available timing information, macroscopic parameters, staining parameters, and/or physiological parameters. Rather, information can be omitted as appropriate.

A number of implementations have been described. Nevertheless, it will be understood that various modifications may be made. Accordingly, other implementations are within the scope of the following claims.

What is claimed is:

1. The methods and apparatuses for dating hemorrhages disclosed herein.
